(19) United States
(12) Patent Application Publication
(10) Pub. No.: US 2023/0354794 A1
(43) Pub. Date: Nov. 9, 2023

(54) FISHING REEL HAVING A ROTARY SPOOL WITH A MAGNETIC BRAKING SYSTEM

(71) Applicant: FEEL-O S.R.L., Miliano (IT)

(72) Inventors: Alberto Luigi COLOGNI, Osio Sopra (IT); Mattia DE SANTIS, Tribiano (IT); Luigi D'ERRICO, Orsenigo (IT); Federico MADONA, Crema (IT); Ivo Emanuele Francesco BONIOLO, Bovisio Masciago (IT); Sergio Matteo SAVARESI, Cremona (IT)

(73) Assignee: FEEL-O .S.R.L., Miliano (IT)

(21) Appl. No.: 18/246,055

(22) PCT Filed: Sep. 21, 2021
(86) PCT No.: PCT/IB2021/058566

§ 371 Date: Mar. 21, 2023

(30) Foreign Application Priority Data
Sep. 21, 2020 (IT) 102020000022192

(51) Int. Cl. A01K 89/033; A01K 89/0155; A01K 89/015

(52) U.S. Cl. CPC A01K 89/033; A01K 89/01555; A01K 89/0178

(57) ABSTRACT

A braking system for a fishing reel (10) is described, of the type comprising a body (12) and a spool (16) made of metal and rotatably supported by the body (12) for rotation about an axis of rotation (y) to allow, depending on its direction of rotation, winding or unwinding of a fishing line (18). The braking system comprises: at least one magnet (26) arranged to be movably mounted on the body (12), next to the spool (16), to generate eddy currents in the spool (16) by electromagnetic induction, as a result of the rotation of the spool (16); adjusting means (32, 38) associated to the at least one magnet (26) to adjust distance of the latter from the spool (16), thereby adjusting the intensity of the braking force applied onto the spool (16); and electronic control means (44) connected to the adjusting means (32, 38) and programmed to control the adjusting means (32, 38) so as to adjust the distance of the at least one magnet (26) from the spool (16), and hence the braking force applied onto the spool (16).

### TECHNICAL FIELD OF THE INVENTION

The present invention relates in general to the field of the fishing reels. More specifically, the present invention relates to a fishing reel of the rotar-spool type.

### STATE OF THE ART

As it is known, there are basically two categories of fishing reels, namely the reels with a fixed spool (or so-called spinning reels) and the reels with a rotary spool (or so-called casting reels). In the fixed-spool reels the spool on which the fishing line is wound is fixedly mounted on the fishing rod, with its axis parallel to the longitudinal axis of the rod. Winding of the fishing line on the spool and unwinding of the fishing line from the spool are allowed by the rotation in either direction of a bail arm, driven by the user by means of a suitable handle, about an axis of rotation coinciding with the axis of the spool. On the other hand, in case of a rotary-spool reel the spool is mounted on the fishing rod so as to be rotatable about its axis, which in this case is oriented perpendicular to the longitudinal axis of the fishing rod. Furthermore, while in the fixed-spool version the reel is mounted underneath the fishing rod, i.e. on a side of the fishing rod which in the condition of use is facing downwards, in the rotary-spool version the reel is mounted on the upper side of the fishing rod, i.e. on the side which in use is facing upwards.

A problem connected with the use of rotary-spool reels is tangling of the fishing line (i.e. the creation of the so-called “wigs”) that may occur during launch of the fishing line, in particular in case of a non-skilled user and in case of changes in the speed of the fishing line, due for example to the wind or to the contact of the fishing line with the water. The fishing line may be so tangled up as to compel the user to replace the entire spool. It is therefore a particularly annoying problem, for which some solutions are already known, but are not fully effective.

A first solution consists in braking the spool with the thumb during launch of the fishing line. Such a solution requires, however, a certain level of expertise of the user and, in any case, is not able to completely prevent the generation of wigs.

Other solutions are based on the use of braking systems integrated in the reel, which braking systems apply a braking action onto the spool during launch of the fishing line. For example, mechanical braking systems are known, which use the centrifugal force generated as a result of the rotation of the spool during launch of the fishing line to urge a number of friction elements mounted on the spool against a stationary braking surface. As an alternative to mechanical braking systems, magnetic braking systems are known, in which braking of the spool is obtained in contactless mode due to the eddy currents generated by electromagnetic induction in the spool (which in this case is made of metal) by one or more magnets carried by the body of the reel. Hybrid braking systems are also known, which comprise both a centrifugal braking device and a magnetic braking device which can be suitably controlled by the user independently of each other to operate along with each other or alternatively to each other.

Finally, a rotary-spool fishing reel is also known, which is provided with a “smart” braking system able to automatically control braking of the spool. It is the Metanium DC fishing reel manufactured by Shimano, in which the braking system comprises copper coils which, when crossed by current, generate a magnetic field, and an electronic control unit configured to establish, at any given time during the launch phase, the correct braking force to be applied onto the spool and to generate electric pulses in the copper coils accordingly, so as to apply the calculated braking force onto the spool. Such an automatic braking system produces a braking action which has turned out to be “jerky”, i.e. not very smooth. Furthermore, the average user, which is used to put his thumb onto the fishing line to brake the spool, tends to brake in this manner also when using a reel provided with an automatic braking system.

### SUMMARY OF THE INVENTION

It is an object of the present invention to provide a braking system for a rotary-spool fishing reel which is improved over the prior art discussed above.

This and other objects are fully achieved according to the present invention by virtue of a braking system as defined in the enclosed independent claim 1. The present invention also relates to a fishing reel provided with a rotary spool as defined in claim 13.

Preferred embodiments of the present invention are set forth in the dependent claims.

In short, the invention is based on the idea of associating to the rotary spool, made of metal, of the fishing reel a magnetic braking system comprising
at least one magnet arranged to be movable mounted on a body of the reel, next to the spool, to generate by electromagnetic induction, as a result of the rotation of the spool, eddy currents in the spool;
adjusting means associated to said at least one magnet to adjust the distance of the latter from the spool, thereby adjusting the intensity of the braking force applied onto the spool; and
electronic control means programmed to control the adjusting means so as to adjust the distance of said at least one magnet from the spool, and hence the braking force applied onto the spool.

By virtue of such a braking system it is possible to adjust the braking force applied onto the spool in a more precise and smooth manner than in the above-discussed prior art.

According to an embodiment, the braking system further comprises detecting means for detecting an initial tangling condition of the fishing line on the spool and generating a corresponding warning signal, and first sensor means for generating first measure signals indicative of the rotational speed of the spool. In this case, the electronic control means are programmed to control the adjusting means, in case of generation of the warning signal by the detecting means, so as to adjust, based on the first measure signals, the distance of said at least one magnet from the spool, and hence the braking force applied onto the spool, to prevent tangling of the fishing line on the spool.

By virtue of such a configuration, the braking system is able to automatically adjust the braking force to be applied onto the spool to prevent tangling of the fishing line, promptly acting on the spool as soon as the detecting means detect an initial tangling condition.

Preferably, the detecting means are optical means, and more in particular they include a so-called ToF (Time of Flight) sensor.

The first sensor means include for example an optical angular position transducer.

According to an embodiment, the adjusting means comprise an electric motor, in particular a brushed DC motor, and a motion conversion mechanism including a rotating input member connected to the rotor of the electric motor and a translating output member connected to the magnet(s) to cause it/them to move towards or away from the spool, in particular along a direction parallel to the axis of rotation of the spool.

Preferably, the braking system further comprises a button arranged to be pressed by the user and second sensor means for generating second measure signals indicative of the pressure applied by the user onto the button. In this case, the electronic control means are programmed to control the adjusting means so as to apply onto the spool a braking force proportional to the pressure applied by the user onto the button.

Advantageously, the braking system further comprises third sensor means for providing a signal indicative of the distance of the magnet (or magnets) from the spool, in which case the electronic control means are programmed to control the adjusting means using as feedback signal the signal provided by the third sensor means.

Preferably, the third sensor means comprise an angular position transducer, for example a magnetic one, arranged to detect the angular position of the rotor of the electric motor or of the input member of the motion conversion mechanism.

According to an embodiment, the braking system further comprises fourth sensor means arranged to provide a signal indicative of the current absorbed by the electric motor, in which case the electronic control means are programmed to check the signal received from the fourth sensor means and to stop power supply of the electric motor when the current absorbed by the electric motor exceeds a given threshold value.

Further features of the present invention will be apparent from the following detailed description, given purely by way of non-limiting example.

### BRIEF DESCRIPTION OF THE DRAWINGS

In the following detailed description of the invention reference will be made to the attached drawings, where:

FIGS. 1 and 2 are perspective views, from the front side and from the rear side, respectively, of a fishing reel provided with a magnetic braking system according to the present invention;

FIGS. 3 and 4 are exploded views, from the rear side and from the front side, respectively, of the fishing reel of FIGS. 1 and 2;

FIGS. 5 and 6 are section views of the fishing reel of FIGS. 1 and 2, in a first operating condition in which the magnets of the braking system are at the largest distance from the spool, and hence the braking force applied onto the spool reaches its lowest intensity, and in a second operating condition in which the magnets of the braking system are at the smallest distance from the spool, and hence the braking force applied onto the spool reaches its highest intensity, respectively;

FIG. 7 is a schematic diagram of the control architecture of the braking system of the fishing reel of FIGS. 1 and 2;

FIG. 8 is a section view of a fishing reel provided with a magnetic braking system according to a further embodiment of the present invention; and

FIGS. 9 to 11 are perspective views of the fishing reel of FIG. 8, which differ from each other in the type of transmission mechanism used in the adjustment device of the braking system.

### DETAILED DESCRIPTION OF PREFERRED EMBODIMENTS

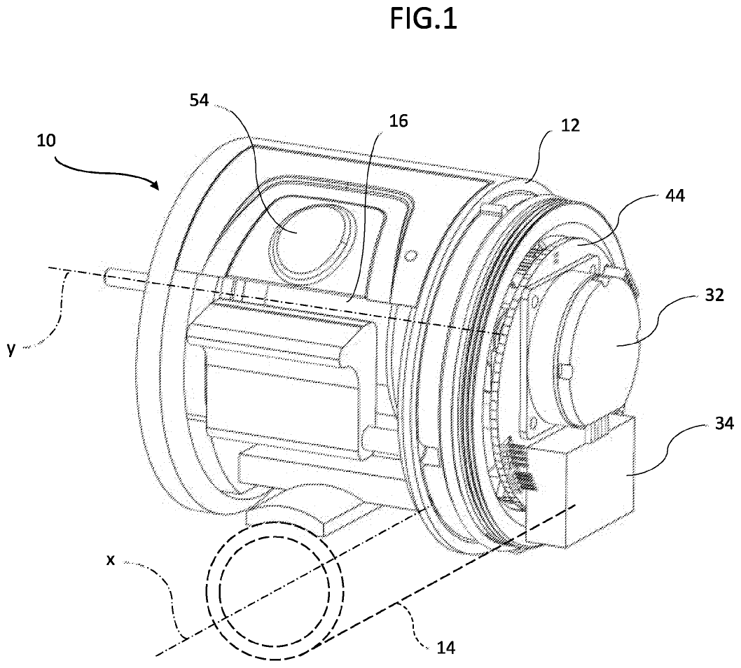

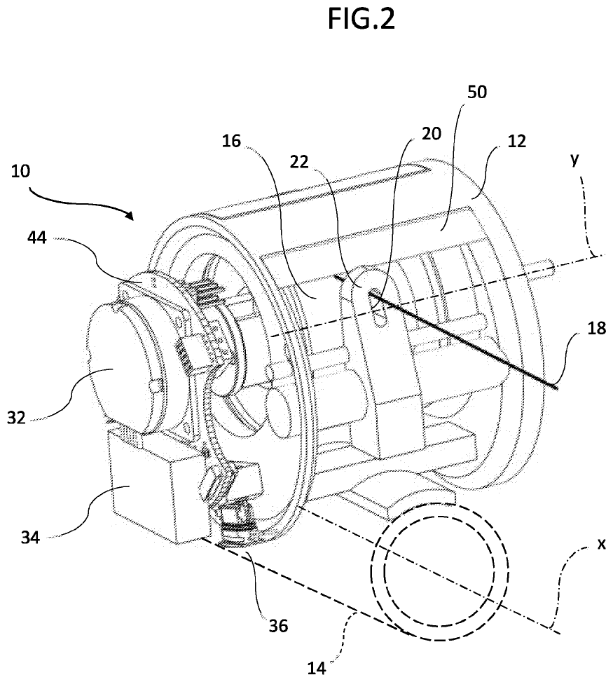

With reference first to FIGS. 1 and 2, a rotary-spool fishing reel provided with a magnetic braking system according to the present invention is generally indicated 10.

The reel 10 basically comprises a body 12 arranged to be mounted on a fishing rod 14 (only partially shown in dashed line), a spool 16 carried by the body 12 so as to be rotatable about an axis of rotation y substantially perpendicular to the longitudinal axis (indicated x) of the fishing rod 14 and a magnetic braking system arranged to apply a braking force onto the spool 16.

The spool 16 is made of metal, in particular metal with good properties in terms of electrical conductivity.

A fishing line 18 is wound on the spool 16 and is guided, when it leaves the spool 16, in a slot 20 of a line-guiding member 22.

A handle (not shown, but of per-se-known type) is connected to the spool 16 and, by means of the handle, the user is able to control rotation of the spool 16 in a given direction to wind the fishing line 18.

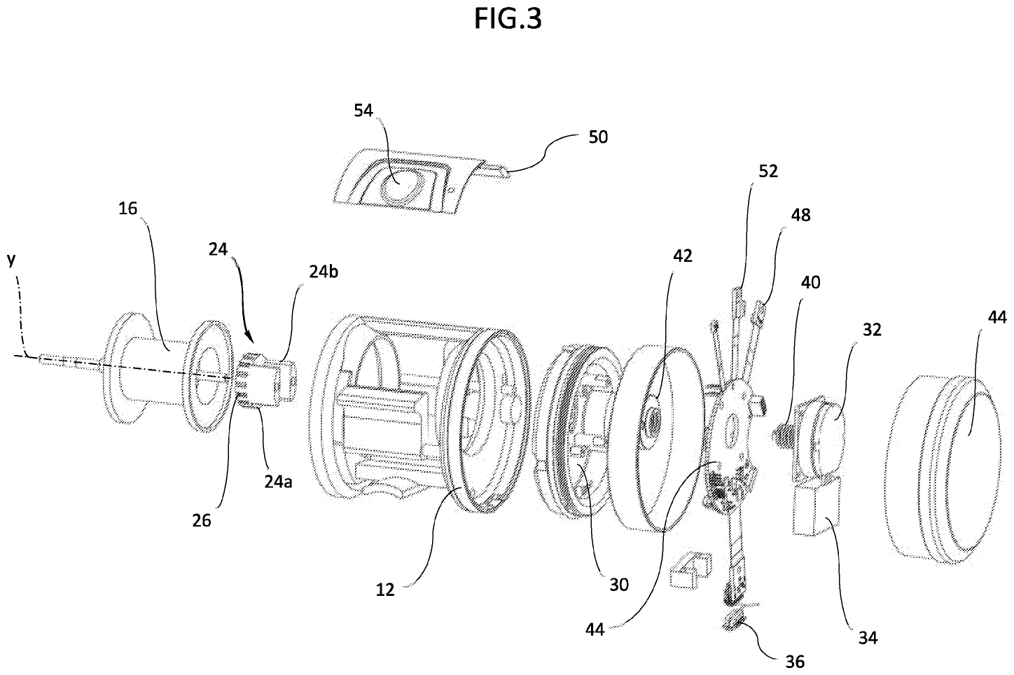

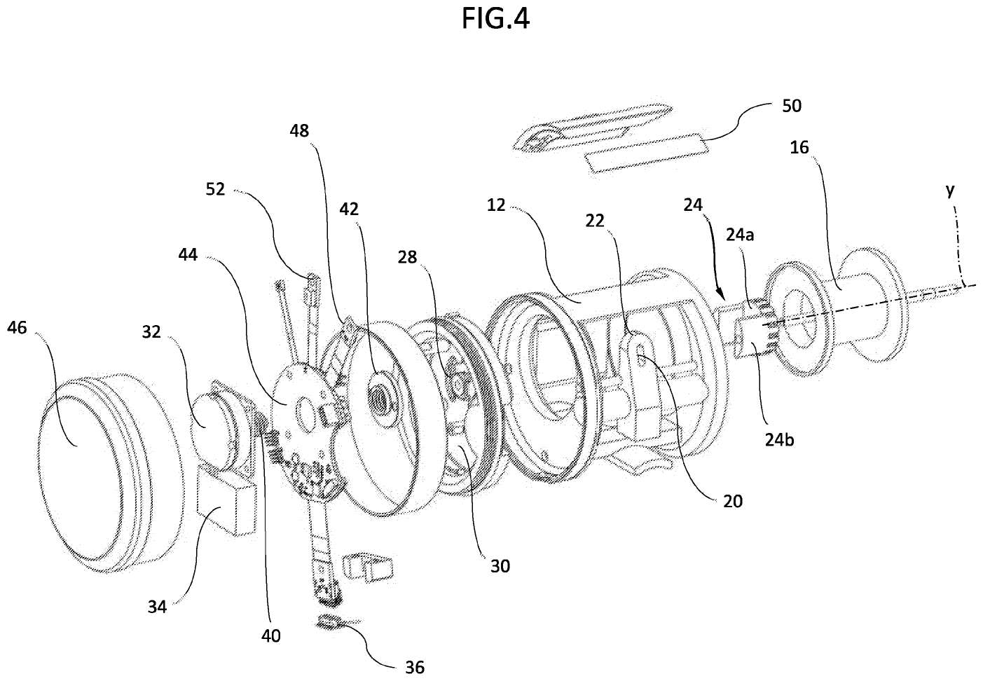

As can be seen in particular in FIGS. 3 and 4, the magnetic braking system comprises a magnetic member 24, that is to say, a member carrying at least one permanent magnet 26 (a plurality of magnets 26, in the example proposed herein), which is mounted on the body 12 so as to be able to shift along a shift direction coinciding with, or more generally parallel to, the axis of rotation y of the spool 16. As a result of the rotation of the spool 16 the magnets 26 generate eddy currents in the spool by electromagnetic induction, thereby applying onto the spool a braking force whose intensity is proportional to the distance between the magnets 26 and the spool 16.

According to the embodiment illustrated herein, the magnetic member 24 comprises a head 24a, for example of disc-like shape, on which the magnets 26 are mounted, and a pair of cylindrical guide elements 24b slidably guided in respective openings 28 provided in a bearing plate 30 mounted on the body 12. The magnetic member 24 is arranged coaxially with the spool 16, in particular in a seat 16a provided inside the spool, and hence in this case the shift direction of the magnetic member 24 coincides with the axis of rotation y of the spool 16.

The magnetic braking system further comprises an adjustment device arranged to move the magnetic member 24 along the aforementioned shift direction to adjust the distance thereof from the spool 16, thereby changing the intensity of the braking force applied onto the spool. The adjustment device comprises an electric motor 32, in particular a brushed DC electric motor supplied by a battery 34 (which may be recharged by means of a USB connector 36). The adjustment device further comprises a motion conversion mechanism 38, with an input member 40 drivingly connected for rotation with the rotor of the electric motor 32 and with an output member 42 able to shift along the aforementioned shift direction. In the embodiment illustrated herein, the electric motor 32 is arranged with its rotor coaxial with the magnetic member 24 and the spool 16 and the motion conversion mechanism 38 is a screw and nut mechanism, wherein the input member 40 is configured as a screw and the output member 42 is configured as a nut. Therefore, by causing the rotor of the electric motor 32 to rotate in either direction, translation of the magnetic member 24 in either direction is obtained by means of the motion conversion mechanism 38, and hence an increase or a reduction in the distance between the magnetic member 24 and the spool 16 is obtained, which results in an increase or a reduction, respectively, in the intensity of the braking force applied onto the spool 16.

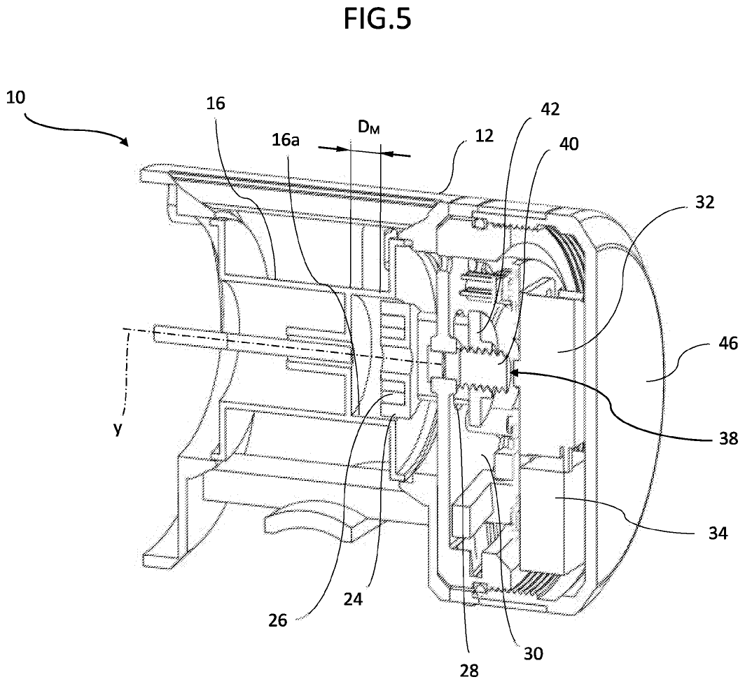

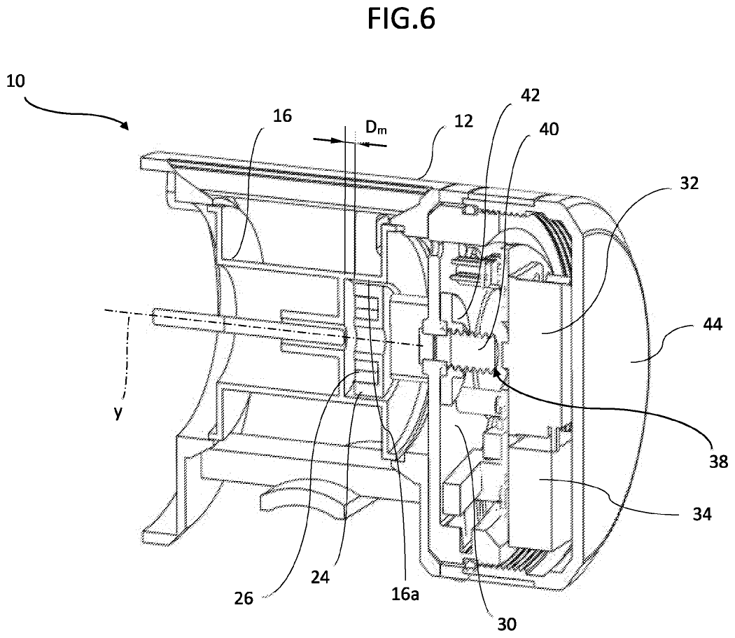

In particular, FIG. 5 shows a first operating condition of the braking system in which the magnetic member 24 is at its largest distance from the spool 16, and hence the intensity of the braking force applied onto the spool takes its lowest value, while FIG. 6 shows a second operating condition of the braking system in which the magnetic member 24 is at its smallest distance from the spool 16, and hence the intensity of the braking force applied onto the spool takes its highest value.

The braking system further comprises an electronic control unit 44, which is made in the present case as an electronic board, programmed to control the electric motor 32 in order to adjust the braking force applied onto the spool 16 based on input signals provided by a number of sensors.

The electronic control unit 44, as well as the electric motor 32 and the battery 34, are mounted on the bearing plate 30 and enclosed by a cover 46 (which in FIGS. 1 and 2 is removed from the reel, while it is shown in FIGS. 3 to 6).

The aforementioned sensors include an optical sensor 48 which is arranged in front of the fishing line 18 leaving the spool 16, in particular upstream of the line-guiding member 22, and is arranged to detect an initial tangling condition of the fishing line on the spool and to send, accordingly, a warning signal to the electronic control unit 44. In particular, the optical sensor 48 is able to detect an increase in the volume of the fishing line 18 in a given working area, due for example to the formation of a bend, which indicates that the fishing line is about to tangle up. The optical sensor 48 is advantageously formed by a so-called ToF (Time of Flight) sensor. In order to avoid detection errors due to the sun light, the working area of the optical sensor 48 is protected against the light by means of a sunshade wing 50 mounted on the body 12.

Instead of an optical sensor as detecting means for detecting an initial tangling condition of the fishing line 18, other types of sensor might be used, such as for example a sensor arranged to detect the tension of the fishing line or a sensor arranged to detect the linear speed of the fishing line leaving the spool. In fact, if a reduction in the tension of the fishing line leaving the spool occurred, this would indicate that the fishing line is beginning to tangling up on the spool. Likewise, if the linear speed of the fishing line leaving the spool was lower than the one expected on the basis of the rotational speed of the spool, this would indicate that the fishing line is about to tangle up on the spool.

An angular speed sensor 52 is also provided, which is advantageously formed by an optical encoder, for detecting the angular speed of the spool 16.

Based on the signals provided by the optical sensor 48 and by the angular speed sensor 52, the electronic control unit 44 suitably controls the electric motor 32 so as to adjust the braking force applied onto the spool 16 in order to prevent the fishing line 18 from tangling up on the spool. If the optical sensor 48 detects an initial tangling condition, then the electronic control unit 44 suitably adjusts the braking force applied onto the spool 16 so as to avoid tangling up of the fishing line and ensure that the fishing line 18 is smoothly unwound from the spool.

Advantageously, the electronic control unit 44 also receives, as input, the signal provided by an angular position sensor (not shown, but of per-se-known type), advantageously formed by a magnetic encoder, arranged to detect the angular position of the rotor of the electric motor 32, that is to say, the angular position of the input member 40 of the motion conversion mechanism 38, and hence to provide the electronic control unit 44 with a signal indicative of the distance of the magnetic member 24 from the spool 16. The electronic control unit 44 is thus able to carry out a closed-loop control of the braking force based on the position signal provided by this angular position sensor.

Preferably, the braking system further comprises, mounted on the body 12, a button 54 arranged to be pressed by the user and a pressure sensor (not shown, but of per-se-known type) connected to the electronic control unit 44 to provide the latter with a measure signal indicative of the pressure applied by the user onto the button 54. In this case, the electronic control unit 44 is programmed to control the electric motor 32 in such a manner as to apply onto the spool 16 a braking force proportional to the pressure applied by the user onto the button 54. The user provides therefore a braking command by pressing the button 54 with a given force and this command is detected and interpreted by the electronic control unit 44 to be converted into a suitable control signal for the electric motor 32. In particular, if the pressure on the button 54 increases the electric motor 32 will be controlled by the electronic control unit 44 to move the magnetic member 24 towards the spool 16 so as to increase the braking force, whereas if the pressure on the button 54 decreases the electric motor 32 will be controlled by the electronic control unit 44 to move the magnetic member 24 away from the spool 16 so as to reduce the braking force.

Advantageously, the button 54 is configured as a haptic button, i.e. a button able to give to the user a tactile feedback depending on the intensity of the braking force applied onto the spool 16.

Preferably, the braking system further comprises a current sensor (not shown, but of per-se-known type) arranged to provide the electronic control unit 44 with a signal indicative of the current absorbed by the electric motor 32. The electronic control unit 44 is in this case programmed to check this signal and, in case it exceeds a given threshold value (indicating an excessive absorption of current), to stop power supply of the electric motor 32. Furthermore, the current sensor is used every time the device is switched on, to carry out the calibration of the zero position of the angular position sensor associated to the electric motor 32.

The braking system of the present invention may advantageously be provided also as a kit to be mounted on existing rotary-spool reels with no braking system.

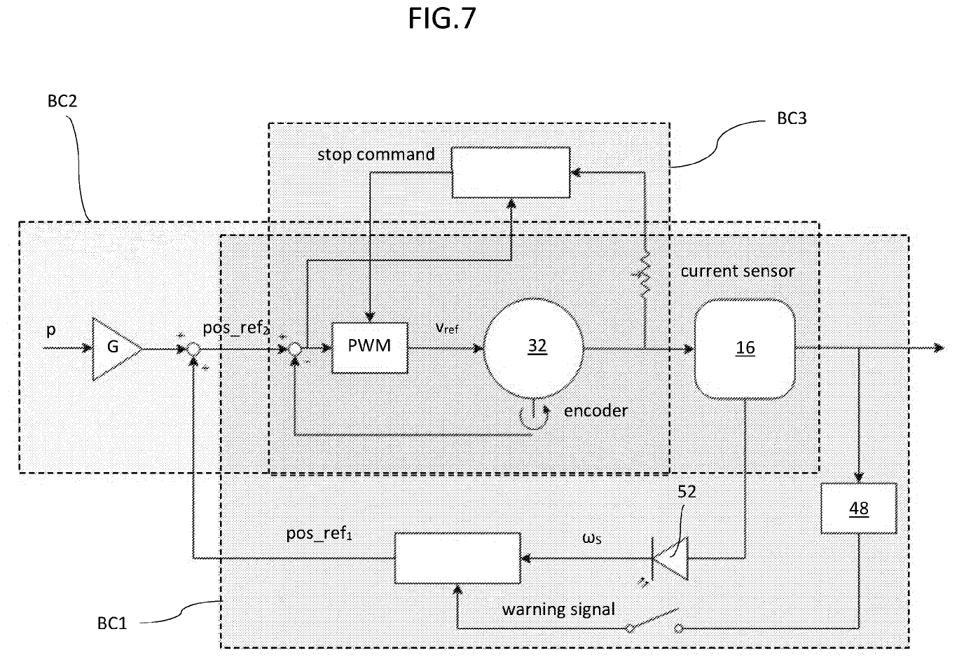

Finally, with reference to the diagram of FIG. 7, the control architecture of the electronic control unit 44 basically includes three control blocks, indicated BC1, BC2 and BC3, respectively.

The control block BC1, configured as a closed-loop control block, is activated by the warning signal generated by the optical sensor 48 in case of detection of an initial tangling condition of the fishing line 18 on the spool 16. The control block BC1 remains therefore “sleeping” until a warning signal is generated by the optical sensor 48. Once activated, the control block BC1 generates, as output, a first reference value pos_ref₁ for the position of the magnetic member 24 relative to the spool 16, and hence a reference value for the braking force applied onto the spool, depending on the angular speed of the spool (indicated ωₛ) detected by the angular speed sensor 52.

The control block BC2 is configured to control the electric motor 32 based on the command provided by the user by pressing on the button 54, so as to generate a braking force onto the spool 16 whose intensity is proportional to the pressure with which the button 54 is pressed. The value of the pressure on the button 54 (indicated p), provided by the pressure sensor associated to the button, is converted with a suitable gain G into a second reference value pos_ref₂ for the position of the magnetic member 24 relative to the spool 16, which is compared with the first reference value pos_ref₁ (if provided by the control block BC1, that is to say, in case of activation of this control block) to generate the input signal for the controller (made in particular as a PWM circuit) of the electric motor 32. Based on this input signal, the controller outputs a reference speed signal v_{ref} for the electric motor 32. Preferably, the controller operates by receiving, as feedback signal, the position of the magnetic member 24 relative to the spool 16 obtained from the information about the angular position of the rotor of the electric motor 32 provided by the associated angular position sensor.

Finally, the control block BC3 acts as a monitoring block that checks the current absorbed by the electric motor 32 (via the measure signal provided by the current sensor associated to the electric motor 32), as well as the linear position of the magnetic member 24, and generates a stop signal for the controller of the electric motor 32 if operation anomalies in the control flow are detected, in particular if a value of the current absorbed by the electric motor 32 higher than a given threshold value is detected.

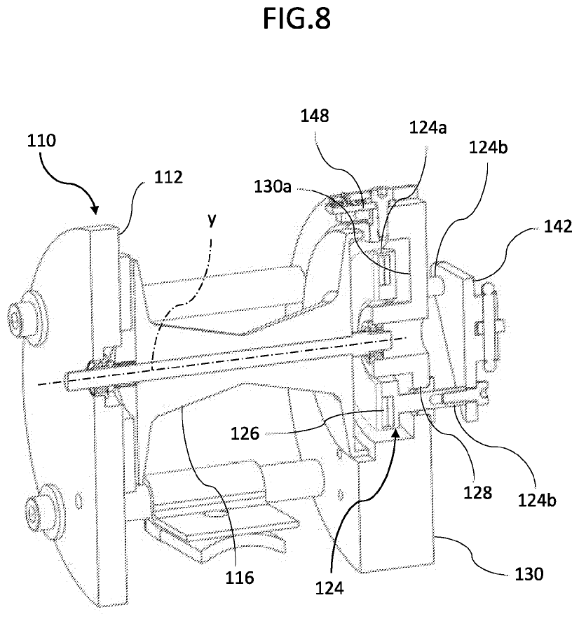

A further embodiment of a fishing reel provided with a magnetic braking system is shown in FIGS. 8 to 11, where parts and elements identical or corresponding to those of the preceding Figures have been given the same reference numerals, increased by 100.

In the following description of that embodiment, only those aspects of the fishing reel, in particular of the relating magnetic braking system, will be illustrated which differ from what has been illustrated above with reference to the preceding Figures. As regards the other aspects, what has been already explained in connection with the embodiment of FIGS. 1 to 7 still applies.

With reference first to FIG. 8, the magnetic member 124 comprises a head 124a, in particular of annular shape, on which the magnets 126 are mounted, and a plurality of cylindrical guide elements 124b, in particular three cylindrical guide elements 124b arranged at 120° to each other (only two of which can be seen in the section view of FIG. 8), which are slidably received in respective openings 128 provided in a plate 130 of the body 112 to guide the translational movement of the magnetic member 124. More specifically, the head 124a of the magnetic member 124 is arranged coaxially with the spool 116 in a seat 130a having a corresponding shape (in the present case an annular shape) provided on an inner side of the plate 130, i.e. on the side facing towards the spool 116. The cylindrical guide elements 124b are connected, at their ends opposite to the head 124a, with a plate-like member 142, which is arranged outside the body 112 and on which the adjustment device of the braking system acts.

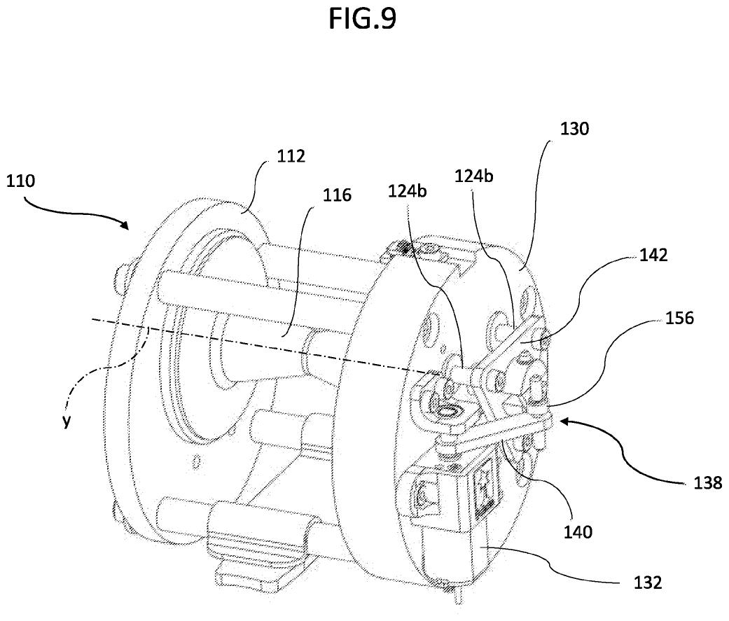

With reference now to FIGS. 9 to 11, the adjustment device comprises an electric motor 132, in particular a brushed DC electric motor supplied by a battery (not shown herein), and a motion conversion mechanism 138 interposed between the electric motor 132 and the plate-like member 142 to cause the latter, along with the magnetic member 124, to shift in either direction along the aforementioned shift direction. In all the three examples of the adjustment device shown in FIGS. 9 to 11 the electric motor 132 is mounted on the outer side of the plate 130 of the body 112 with the axis of rotation (indicated z) of its rotor arranged perpendicular to the axis of rotation y of the spool 116, and hence perpendicular to the shift direction of the magnetic member 124 (i.e. of the plate-like member 142).

In the example of FIG. 9, the motion conversion mechanism 138 is configured as a crank and connecting rod mechanism, with a crank 140 drivingly connected for rotation with the rotor of the electric motor 132 and a connecting rod 156 hinged at an end thereof to the crank 140 and at the opposite end to the plate-like member 142. Therefore, by causing rotation of the rotor of the electric motor 132 about its axis of rotation z in either direction, the plate-like member 142, along with the magnetic member 124, is caused to shift in either direction by virtue of the crank and connecting rod mechanism, which causes an increase or a reduction in the distance between the magnetic member 124 and the spool 116 and a resulting increase or reduction, respectively, in the intensity of the braking force applied onto the spool 116.

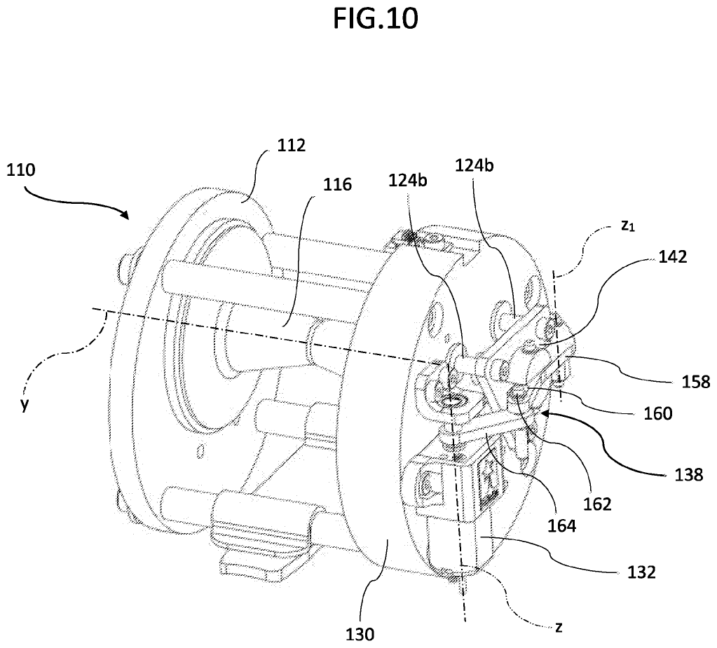

In the example of FIG. 10, the motion conversion mechanism 138 is configured as an oscillating glyph mechanism. The mechanism comprises in this case an oscillating glyph 158, which is hinged at an end thereof to the plate 130 of the body 112 so as to oscillate about an axis of rotation z₁ parallel to the axis z of the rotor of the electric motor 132. The oscillating glyph 158 has at its opposite end a slot 160 in which a pin 162 carried by a handle 164 drivingly connected for rotation with the rotor of the electric motor 132 slidably engages. Therefore, by causing rotation of the rotor of the electric motor 132 about its axis of rotation z in either direction, the plate-like member 142, along with the magnetic member 124, is caused to shift in either direction by virtue of the oscillating glyph mechanism, which causes an increase or a reduction in the distance between the magnetic member 124 and the spool 116 and a resulting increase or reduction, respectively, in the intensity of the braking force applied onto the spool 116.

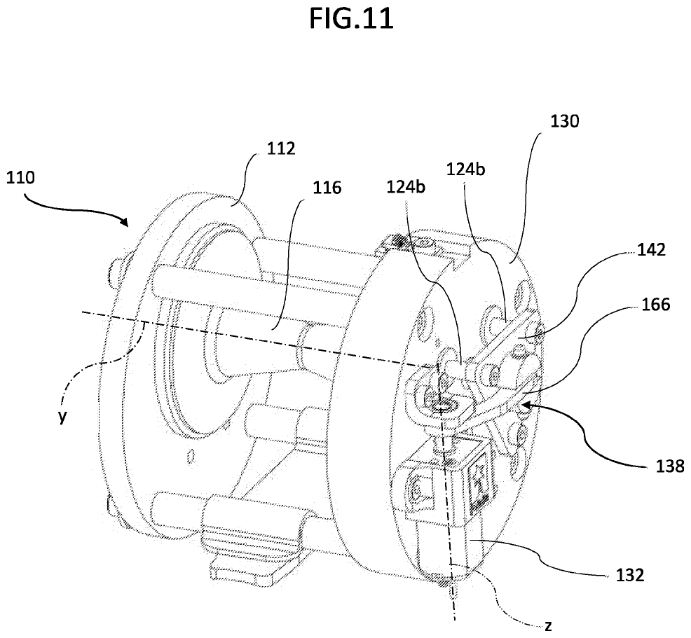

In the example of FIG. 11, the motion conversion mechanism 138 is configured as a lever mechanism comprising a lever 166 which is drivingly connected for rotation with the rotor of the electric motor 132 and is hinged to the plate-like member 142, in such a manner that rotation in either direction of the rotor of the electric motor 132 about its axis of rotation z results, by virtue of the lever 166, in a translation of the plate-like member 142, along with the magnetic member 124, in either direction and hence in an increase or a reduction in the distance between the magnetic member 124 and the spool 116, and therefore in an increase or a reduction, respectively, in the intensity of the braking force applied onto the spool 116.

The present invention has been described herein with reference to preferred embodiments thereof. It is to be intended that other embodiments may be envisaged, which share with those described herein the same inventive concept, as defined by the scope of the enclosed claims.

1. A braking system for a fishing reel, the fishing reel comprising a body and a spool made of metal and rotatably supported by the body for rotation about an axis of rotation to allow, depending on its direction of rotation, winding or unwinding of a fishing line, the braking system comprising
at least one magnet arranged to be movably mounted on the body, next to the spool, to generate eddy currents in the spool by electromagnetic induction, as a result of the rotation of the spool;
an adjusting unit means associated to said at least one magnet to adjust the distance of the latter from the spool, thereby adjusting the intensity of the braking force applied onto the spool; and
an electronic control unit connected to said adjusting unit and programmed to control said adjusting unit so as to adjust the distance of said at least one magnet from the spool, and hence the braking force applied onto the spool.

2. The braking system according to claim 1, further comprising a detecting unit for detecting an initial tangling condition of the fishing line on the spool and generating a corresponding warning signal, and a first sensor device for generating first measure signals indicative of a rotational speed of the spool, and wherein said electronic control unit is also connected to said detecting unit and to said first sensor device and is programmed to control, in case of generation of said warning signal, said adjusting unit based on said first measure signals to prevent tangling of the fishing line on the spool.

3. The braking system according to claim 2, wherein said detecting unit includes an optical sensor, in particular a ToF sensor.

4. The braking system according to claim 2, wherein said first sensor device includes include an optical angular position transducer.

5. The braking system according to claim 1, wherein the braking system further comprises a button arranged to be pressed by a user and a second sensor device for generating second measure signals indicative of a pressure applied by the user onto the button, and wherein said electronic control unit is programmed to control said adjusting unit means so as to apply onto the spool a braking force proportional to the pressure applied by the user onto the button.

6. The braking system according to claim 1, wherein the braking system further comprises a third sensor device for providing a signal indicative of a distance of said at least one magnet from the spool, and wherein said electronic control unit is programmed to control said adjusting unit using as feedback signal the signal provided by said third sensor device.

7. The braking system according to claim 1, wherein said adjusting unit comprises an electric motor and a motion conversion mechanism including a rotating input member, connected to a rotor of the electric motor, and a translating output member, connected to said at least one magnet, to cause movement of the latter towards or away from the spool, in particular along a direction parallel to said axis of rotation.

8. The braking system according to claim 6, wherein said adjusting unit comprises an electric motor and a motion conversion mechanism including a rotating input member, connected to a rotor of the electric motor, and a translating output member, connected to said at least one magnet, to cause movement of the latter towards or away from the spool, in particular along a direction parallel to said axis of rotation, and wherein said third sensor device comprises an angular position transducer, in particular a magnetic one, for detecting an angular position of the rotor of the electric motor or of the input member of the motion conversion mechanism.

9. The braking system according to claim 7, wherein the braking system further comprises a fourth sensor device for providing a signal indicative of a current absorbed by the electric motor, and wherein said electronic control unit is programmed to check the signal received from said fourth sensor device and stop power supply of the electric motor when the current absorbed by the electric motor exceeds a given threshold value.

10. The braking system according to claim 7, further comprising a magnetic member on which said at least one magnet is mounted, said magnetic member being arranged coaxial with the spool, being supported by the body so as to be shiftable along the axis of rotation of the spool and being also drivingly connected for translation with the output member of the motion conversion mechanism.

11. The braking system according to claim 10, wherein the electric motor is arranged with its rotor coaxial with the magnetic member and the spool and wherein the motion conversion mechanism is a screw and nut mechanism.

12. The braking system according to claim 10, wherein the electric motor is arranged with its rotor perpendicular to the axis of rotation of the spool and wherein the motion conversion mechanism is a crank and connecting rod mechanism or an oscillating glyph mechanism or a lever mechanism.

13. A fishing reel comprising a body arranged to be mounted on a fishing rod, a spool made of metal and rotatably supported by the body for rotation about an axis of rotation, a fishing line wound on the spool, and a braking system according to claim 1.

14. The braking system according to claim 3, wherein said first sensor device includes an optical angular position transducer.

15. The braking system according to claim 8, wherein the braking system further comprises a fourth sensor device for providing a signal indicative of a current absorbed by the electric motor, and wherein said electronic control unit is programmed to check the signal received from said fourth sensor device and stop power supply of the electric motor when the current absorbed by the electric motor exceeds a given threshold value.
